(19) United States
(12) Patent Application Publication
(10) Pub. No.: US 2010/0092632 A1
(43) Pub. Date: Apr. 15, 2010

(54) METHOD FOR THE PRODUCTION OF A FOOD, A FOOD SUPPLEMENT, OR CONSUMABLE GOOD

(76) Inventor: Kurt Vymazal, Wolfsgraben (AT)

Correspondence Address: BODNER & O'ROURKE, LLP, 425 BROADHOLLOW ROAD, SUITE 108, MELVILLE, NY, 11747, US

(21) Appl. No.: 12/450,102

(22) PCT Filed: Mar. 13, 2007
(86) PCT No.: PCT/EP2007/052364

§ 371 Date: Dec. 18, 2009

(51) Int. Cl. A23L 1/0524; A23L 1/05; A23L 1/068; A23L 3/00

(52) U.S. Cl. 426/311; 426/577; 426/519; 426/410; 426/330

(57) ABSTRACT

The invention relates to a method for the production of a food, a food supplement, or consumable good, wherein said good contains a mixture of water soluble carbohydrates, pectin, water, Ca²⁺ ions and at least one thickening agent. According to the invention, fruit juice concentrate and/or vegetable juice concentrate and/or alcohol are added to the mixture following warming and until the pectin is dissolved and the solution is clear, wherein a product which is ready for consumption and which has a stable shape due to gelatinization is formed when filled into a container, in particular a tube.

The invention relates to a method for producing a foodstuff, a food supplement or luxury food, which contains a mixture of water-soluble carbohydrates, pectin, water, Ca⁺⁺ ions as well as at least one thickening agent, according to the preamble of patent claim 1.

It is known to produce gels that do not have a stable shape in tubes or tube-like containers, said gels being suitable for consumption and being used as food supplements or luxury foods. Typically, gels that do not have a stable shape are filled into and offered in plastic bags, which have a tear-off perforation or can be cut open and cannot be closed again or closed in a hygienically acceptable manner. They are consumed by direct contact with the mouth only, by simultaneously pressing and sucking, or with the aid of a spoon or the like auxiliary tool.

Also known are aluminum tubes with a screw cap, e.g. to receive mustard, mayonnaise, but also jams. Such tubes provided with a screw cap permit the closing and subsequent reuse thereof. The cap avoids a change of the content, e.g. by the influence of atmospheric oxygen.

The products contained in the aforementioned packaging means are fruit pastes, high or low calorie fruit spreads or vegetable pastes or similar paste-like substances.

A method for producing a low calorie fruit product is already known from WO 2002/071817 A1, wherein the fruit material is prepared by intensively mixing all individual ingredients comprising, inter alia, pectin, fruit and sweeteners. A temperature treatment of such mixtures is absolutely imperative for the purpose of pasteurization.

As to the prior art, reference be additionally made to EP 0575179 A2 and DE 10209394 A1.

Based on the foregoing it is the object of the invention to provide a method for producing a semi-solid gel which has a stable shape and which can be taken out of reclosable containers and is suited for the direct consumption by human beings and animals. A consumption is to be possible without any auxiliary means such as spoons or the like.

The foodstuff, food supplement should be at least beneficial to health, the luxury food should serve enjoyment purposes and have a long shelf life, namely without requiring complicated temperature treatment steps that destroy the substances.

Even if smaller or larger amounts of the gel product to be obtained are pressed out repeatedly, e.g. from a tube, the gel-like consistency should be maintained, i.e. an undesired syneresis is to be suppressed.

The solution to the object of the invention is achieved with a method as defined in patent claim 1. The dependent claims define at least useful embodiments and further developments.

Accordingly, the method for producing the foodstuff, food supplement or luxury food is based on a mixture containing water-soluble carbohydrates, pectin, water, Ca⁺⁺ ions as well as at least one thickening agent.

According to the invention the mixture, after heating it to obtain a clear solution of the pectin, is added fruit juice and/or vegetable juice concentrates and/or alcohol so as to obtain by means of gelling a product ready for consumption and with a stable shape when filled into a container, especially into a tube.

The fruit juice and/or vegetable juice concentrates added to the mixture are provided from naturally obtained juices by means of water removal. The fruit juice and/or vegetable juice concentrates are added to the mixture after the gelling agents are dissolved, so that the thermal stress on the fruit juice or vegetable juice concentrates can be kept low.

In order to avoid an undesired phase separation when adding the alcohol to the mixture, the alcohol is added in the direct proximity of a combination of immersion blenders running at high speed and immersed into the mixture, so that the desired homogenous intermixing of the gelling solution takes place.

The aforementioned combination comprises at least two immersion blenders positioned at an angle relative to one another, wherein the angular position of the immersion blenders relative to one another, with the same sense of rotation in the mixing area, results in a contrarotation which extremely enhances the intermixing.

By using the teaching according to the method up to 30 percent by weight of alcohol may be added to the mixture, which is otherwise impossible owing to the phase separation between the alcohol and the pectin-containing gel.

For nonalcoholic gel products containing fruit juice concentrates ascorbic acid and/or sorbic acid and/or the salts thereof are added to the mixture in order to improve the shelf life.

If vegetable juice concentrates are used, especially from earth grown vegetables, an autoclaving is performed, namely in a special temperature range of substantially 120° C. over a period of at least 15 minutes.

If necessary, preservatives may be additionally added to the mixture containing vegetable juice concentrates from earth grown vegetables.

The gel product, which has a stable shape, is filled into a container formed of a non-elastic material so as to avoid a back and forward motion of the gel and, thus, a syneresis when the gel product is squeezed or pressed out of the container. The container is preferably formed of an aluminum tube of the type known per se.

Moreover, the mixture may contain vitamins, caffeine, taurine and/or multiple concentrates of trace elements.

If the container is a metallic tube, it is possible by means of the length of the gel stripe obtained by pressing out to make an estimation of the amount of the product for dosing purposes.

The invention further comprises any products which are obtained according to a method of the above-described type.

The invention will be explained in more detail below by means of an embodiment.

According to the embodiment a semi-solid gel is produced, which has a stable shape and which can be squeezed or pressed out of a reclosable tube or a syringe without a needle, to allow a direct consumption by a human being or an animal. The mere measuring or estimating of the length of the pressed or squeezed out gel stripe permits an approximately dosed consumption of the ingredients. Any auxiliary means are not necessary.

The use of containers in the form of structures that are similar to syringes, which have a scale and no needle, allows an exact dosing, if this is practically intended.

The foodstuff, food supplement or luxury food or animal feed supplement realized according to the invention may be alcoholic or nonalcoholic and is based on pectin. At any rate, the gel-like consistency ensures during the squeezing or pressing out that the product forms a stripe with a stable shape. Even if the stripe is pressed out, for example, on the back of the hand the gel consistency is maintained in a consumption-optimal manner despite the effect of the body temperature, i.e. the product does not flow away.

The product according to the invention is created by mixing, for example, apple or citrus pectin, amidated or not amidated with water-soluble carbohydrates, water, Ca++ ions and thickening agents such as carrageen and locust bean gum or agar-agar. The mixture is heated until a clear solution of the pectin is obtained. Next, fruit juice or vegetable juice concentrates and/or alcohol are added. After the filling preferably into aluminum tubes or similar containers the gel with a stable shape is formed by gelling.

Depending on the type of pectin used, the pH-value of the solution is maintained in a slightly acidic environment of about pH 3.0 to 3.5.

Vitamins, mineral substances, trace elements, flavors, colorants and other substances like caffeine, taurine, glucose and/or other food additives such as preservatives may be added to the mixture so as to create various types of gel.

In a first embodiment of the invention fruit juice and vegetable juice concentrates are used for producing the stable shape gel for enjoyment and/or nutrition purposes.

In a second embodiment of the invention alcohol is used by taking into account a special method for incorporating the alcohol into the gel.

The fruit juice or vegetable juice concentrates are produced from naturally pressed or obtained fruit and vegetable juices, by carefully removing water. Thus, all ingredients of the juice as well as natural flavors and colorants are preserved.

By adding the concentrates after the gelling agents have been dissolved by boiling, the fruit juice or vegetable juice concentrates are subjected to a high temperature of substantially 95° C. for a short time only, so that the color and the flavor are preserved.

It has shown that it is very difficult to mix alcohol into a pectin-containing gel by prior methods, such as stirring, because the phases remain separated and a syneresis occurs.

However, according to one embodiment of the invention the alcohol is added through a conduit which ends directly above the propeller blades of an immersion blender, which runs at a high speed and is immersed into the solution, so that the desired optimal integration of the alcohol into the gel can be achieved.

By doing so, it has proved to be a particular advantage if a second high-speed immersion blender is disposed opposite and in the direct proximity of a first immersion blender at an angle of approximately 120°, so that a homogeneous intermixing of the gelling solution is effected.

As both immersion blenders have the same sense of rotation, an angular arrangement results in a counter-rotating operation. By this method a desired attractive haptic quality, a sufficient homogeneity and a stable texture are obtained. The introduced method allows the realization of alcohol contents of up to 30 percent by weight relative to the mixture.

As the raw materials used are nearly free of germs and the pH-value is in the range of 3.0 to 3.5 a further preservation to obtain a sufficient shelf life is, as such, not required if the above-explained method is used.

In nonalcoholic gels with fruit juice concentrates as basic material the addition of preservatives such as ascorbic acid and/or sorbic acid and/or the salts thereof is recommended.

In nonalcoholic gels with vegetable juice concentrates from earth grown vegetables such as carrots as basic material it is advisable to perform an autoclaving at substantially 120° C. over a treatment period of approximately 15 minutes in addition to adding preservatives such as ascorbic acid and/or sorbic acid and/or the salts thereof.

Due to the non-elastic or rigid wall of the container used, the gel is not subjected to an undesired back and forward motion when it is squeezed or pressed out, but is always oriented in one direction only. Thus, the texture of the gel is maintained and a syneresis is avoided.

As the size and, thus, the thickness of the stable shape gel stripe is consistent the ingredients can be consumed in a dosed manner, if the intended purpose of the products relates to food supplements or drugs.

1. Method for producing a foodstuff, a food supplement or luxury food, which contains a mixture of water-soluble carbohydrates, pectin, water, Ca⁺⁺ ions as well as at least one thickening agent,
characterized in that
the mixture, after heating it to obtain a clear solution of the pectin, is added fruit juice and/or vegetable juice concentrates and/or alcohol so as to obtain by means of gelling a product ready for consumption and with a stable shape when filled into a container, especially into a tube.

2. Method according to claim 1,
characterized in that
the fruit juice and/or vegetable juice concentrates added to the mixture are provided from naturally obtained juices by means of water removal.

3. Method according to claim 1,
characterized in that
the fruit juice and/or vegetable juice concentrates are added to the mixture after the gelling agents are dissolved so as to keep the thermal stress on them low.

4. Method according to claim 1,
characterized in that
in order to avoid a phase separation when adding the alcohol to the mixture, the alcohol is added in the direct proximity of a combination of immersion blenders running at high speed and immersed into the mixture, so that a homogenous intermixing of the gelling solution takes place.

5. Method according to claim 4,
characterized in that
the combination comprises at least two immersion blenders positioned at an angle relative to one another, wherein the angular position of the immersion blenders relative to one another, with the same sense of rotation in the mixing area, results in a contrarotation which enhances the intermixing.

6. Method according to claim 1,
characterized in that
up to 30 percent by weight of alcohol are added to the mixture.

7. Method according to claim 1,
characterized in that
for nonalcoholic gel products containing fruit juice concentrates ascorbic acid and/or sorbic acid and/or the salts thereof are added to the mixture.

8. Method according to claim 1,
characterized in that
for nonalcoholic gel products such as vegetable juice concentrates from earth grown vegetables an autoclaving is performed.

9. Method according to claim 8,
characterized in that
preservatives are added to the mixture.

10. Method according to claim 1,
characterized in that
the product, which has a stable shape, is filled into a container formed of a non-elastic material so as to avoid or suppress a back and forward motion of the gel and, thus, a syneresis when the gel product is squeezed or pressed out of the container.

11. Method according to claim 1,
characterized in that
vitamins, caffeine, taurine and/or multiple concentrates of trace elements and/or mineral substances are added to the mixture.

12. Method according to claim 1,
characterized in that
the container is a metallic tube, wherein by means of the length of the gel stripe obtained by pressing out an estimation of the amount of the product is made for dosing purposes.

13. Product obtained according to a method according to claim 1.

14. Method according to claim 2,
characterized in that
the fruit juice and/or vegetable juice concentrates are added to the mixture after the gelling agents are dissolved so as to keep the thermal stress on them low.

15. Method according to claim 2,
characterized in that
in order to avoid a phase separation when adding the alcohol to the mixture, the alcohol is added in the direct proximity of a combination of immersion blenders running at high speed and immersed into the mixture, so that a homogenous intermixing of the gelling solution takes place.

16. Method according to claim 3,
characterized in that
in order to avoid a phase separation when adding the alcohol to the mixture, the alcohol is added in the direct proximity of a combination of immersion blenders running at high speed and immersed into the mixture, so that a homogenous intermixing of the gelling solution takes place.

17. Method according to claim 2,
characterized in that
up to 30 percent by weight of alcohol are added to the mixture.

18. Method according to claim 3,
characterized in that
up to 30 percent by weight of alcohol are added to the mixture.

19. Method according to claim 4,
characterized in that
up to 30 percent by weight of alcohol are added to the mixture.

20. Method according to claim 5,
characterized in that
up to 30 percent by weight of alcohol are added to the mixture.
